(19) United States
(12) Patent Application Publication
(10) Pub. No.: US 2024/0213628 A1
(43) Pub. Date: Jun. 27, 2024

(54) BATTERY-CELL COUPLING STRUCTURE

(71) Applicant: SUBARU CORPORATION, Tokyo (JP)

(72) Inventor: Yutaka YOKOYAMA, Tokyo (JP)

(21) Appl. No.: 18/520,104

(22) Filed: Nov. 27, 2023

(30) Foreign Application Priority Data
Dec. 21, 2022 (JP) JP 2022-204733

(51) Int. Cl. H01M 50/509; H01M 10/658; H01M 50/209; H01M 50/264

(52) U.S. Cl. CPC H01M 50/509; H01M 10/658; H01M 50/209; H01M 50/264

(57) ABSTRACT

A battery-cell coupling structure includes battery cells and an electrode coupling plate. The battery cells are arranged in a laid manner in a first direction at least in one layer in a thickness direction of the battery cells orthogonal to the first direction. The battery-cell coupling structure is configured to electrically couple the battery cells to each other with the electrode coupling plate. The battery cells each include a first electrode and a second electrode. The electrode coupling plate basically includes an insulating substrate, a first coupling terminal, a second coupling terminal, a third coupling terminal, and a fourth coupling terminal. The electrode coupling plates, depending on presence, absence, and combination of the first, the second, the third, and the fourth coupling terminals, electrically couples or decouples adjacent battery cells of the battery cells in the first direction to couple the battery cells in series, parallel, or series-parallel.

### CROSS-REFERENCE TO RELATED APPLICATIONS

The present application claims priority from Japanese Patent Application No. 2022-204733 filed on Dec. 21, 2022, the entire contents of which are hereby incorporated by reference.

### BACKGROUND

The disclosure relates to a battery-cell coupling structure.

A known battery pack structure is disclosed in, for example, Japanese Unexamined Patent Application Publication (JP-A) No. 2014-199716.

Battery packs, which are formed of multiple battery cells stored in a case so as to be able to output a predetermined voltage and capacity, are widely used as power sources of various devices, vehicles, and the like. Multiple battery cells are stored in a case of a battery module constituting a battery pack, and a positive electrode terminal and a negative electrode terminal are provided on a first side surface of the case. Inside the case, the battery cells are coupled in series, parallel, or series-parallel via bus bars.

Such battery modules are stacked in, for example, three layers and are coupled and fixed to one another via a bracket, and the positive electrode terminals and the negative electrode terminals are electrically coupled to one another via bus bars. As described above, various shapes of bus bars are prepared according to a predetermined voltage or the like of the battery pack, and the battery modules are electrically coupled to one another via the bus bars.

### SUMMARY

An aspect of the disclosure provides a battery-cell coupling structure. The battery-cell coupling structure includes battery cells and an electrode coupling plate. The multiple battery cells are arranged in a laid manner in a first direction at least in one layer in a thickness direction of the battery cells, the thickness direction being orthogonal to the first direction. The battery-cell coupling structure is configured to electrically couple the battery cells to each other with the electrode coupling plate. Each of the battery cells includes a first electrode provided at a first end in a second direction orthogonal to the first direction and a second electrode provided at a second end in the second direction. The electrode coupling plate includes an insulating substrate, a first coupling terminal, a second coupling terminal, a third coupling terminal, and a fourth coupling terminal. The first coupling terminal is provided at one or both of a first end and a second end of a first main surface of the insulating substrate in the thickness direction. The second coupling terminal is provided at one or both of the first end and the second end of a second main surface of the insulating substrate opposite to the first main surface. The third coupling terminal is provided at the first end or the second end so as to extend in the thickness direction of the insulating substrate to electrically couple the first coupling terminal and the second coupling terminal to each other or so as to penetrate through the insulating substrate to be exposed from the first main surface and the second main surface. The fourth coupling terminal is provided at the second end or the first end opposite to the end provided with the third coupling terminal so as to extend in the thickness direction of the insulating substrate to electrically couple the first coupling terminal and the second coupling terminal to each other or so as to penetrate through the insulating substrate to be exposed from the first main surface and the second main surface. One or both of the first coupling terminal and the second coupling terminal of the electrode coupling plate are disposed so as to straddle a boundary between adjacent battery cells of the battery cells in the first direction. Electrode coupling plates including the electrode coupling plate are configured to electrically couple or decouple adjacent battery cells of the battery cells in the first direction to couple the battery cells in series, parallel, or series-parallel depending on combinations of presence and absence of each terminal of the electrode coupling plates corresponding to the first coupling terminal, the second coupling terminal, the third coupling terminal, and the fourth coupling terminal.

An aspect of the disclosure provides a battery-cell coupling structure. The battery-cell coupling structure includes battery cells and an electrode coupling plate. The battery cells are arranged in a laid manner in a first direction at least in one layer in a thickness direction of the battery cells, the thickness direction being orthogonal to the first direction. The battery-cell coupling structure are configured to electrically couple the battery cells to each other with the electrode coupling plate. Each of the battery cells includes a first electrode provided at a first end in the first direction and a second electrode provided at a second end in the first direction. The electrode coupling plate includes an insulating substrate, a first coupling terminal, a second coupling terminal, a third coupling terminal, and a fourth coupling terminal. The first coupling terminal is provided on a first main surface of the insulating substrate in the thickness direction. The second coupling terminal is provided on a second main surface of the insulating substrate opposite to the first main surface. The third coupling terminal is provided so as to extend in the thickness direction of the insulating substrate to electrically couple the first coupling terminal and the second coupling terminal to each other or so as to penetrate through the insulating substrate to be exposed from the first main surface and the second main surface. The fourth coupling terminal is provided so as to extend in the thickness direction of the insulating substrate to electrically couple the first coupling terminal and the second coupling terminal to each other or so as to penetrate through the insulating substrate to be exposed from the first main surface and the second main surface. Electrode coupling plates including the electrode coupling plate comprise each terminal corresponding to the first coupling terminal and the second coupling terminal, and disposed so as to straddle a boundary between adjacent battery cells of the battery cells at least in the first direction such that the first electrode and the second electrode face each other. The electrode coupling plates are configured to electrically couple or decouple adjacent battery cells of the battery cells in the first direction to couple the battery cells in series, parallel, or series-parallel depending on combinations of presence and absence of each coupling terminal of the electrode coupling plates corresponding to the first coupling terminal, the second coupling terminal, the third coupling terminal, and the fourth coupling terminal.

### BRIEF DESCRIPTION OF THE DRAWINGS

The accompanying drawings are included to provide a further understanding of the disclosure and are incorporated in and constitute a part of this specification. The drawings illustrate embodiments and, together with the specification, serve to describe the principles of the disclosure.

FIG. 1 is a perspective view of a battery pack including a battery-cell coupling structure according to an embodiment of the disclosure;

FIG. 2 is a perspective view of a battery cell used in the battery-cell coupling structure according to the embodiment of the disclosure;

FIG. 3A is a perspective view of an electrode coupling plate used in the battery-cell coupling structure according to the embodiment of the disclosure;

FIG. 3B is a cross-sectional view of the electrode coupling plate used in the battery-cell coupling structure according to the embodiment of the disclosure;

FIG. 3C is a cross-sectional view of a modification of the electrode coupling plate used in the battery-cell coupling structure according to the embodiment of the disclosure;

FIG. 4A is a front view of an assembled battery using the battery-cell coupling structure according to the embodiment of the disclosure;

FIG. 4B is a back view of the assembled battery using the battery-cell coupling structure according to the embodiment of the disclosure;

FIG. 5 is a perspective view of an assembled battery using the battery-cell coupling structure according to the embodiment of the disclosure;

FIG. 6A is a front view of the assembled battery using the battery-cell coupling structure according to the embodiment of the disclosure;

FIG. 6B is a back view of the assembled battery using the battery-cell coupling structure according to the embodiment of the disclosure;

FIG. 7 is a perspective view of an assembled battery using the battery-cell coupling structure according to the embodiment of the disclosure;

FIG. 8A is a front view of the assembled battery using the battery-cell coupling structure according to the embodiment of the disclosure;

FIG. 8B is a back view of the assembled battery using the battery-cell coupling structure according to the embodiment of the disclosure;

FIG. 9 is a perspective view of an electrode coupling plate used in the battery-cell coupling structure according to the embodiment of the disclosure;

FIG. 10A is a perspective view of an electrode coupling plate used in a battery-cell coupling structure according to an embodiment of the disclosure;

FIG. 10B is a cross-sectional view of the electrode coupling plate used in the battery-cell coupling structure according to the embodiment of the disclosure;

FIG. 10C is a cross-sectional view of a modification of the electrode coupling plate used in the battery-cell coupling structure according to the embodiment of the disclosure;

FIG. 11A is a perspective view of an electrode coupling plate used in the battery-cell coupling structure according to the embodiment of the disclosure;

FIG. 11B is a perspective view of an electrode coupling plate used in the battery-cell coupling structure according to the embodiment of the disclosure;

FIG. 12A is a perspective view of an assembled battery using the battery-cell coupling structure according to the embodiment of the disclosure;

FIG. 12B is a front view of the assembled battery using the battery-cell coupling structure according to the embodiment of the disclosure;

FIG. 13A is a perspective view of an assembled battery using the battery-cell coupling structure according to the embodiment of the disclosure; and

FIG. 13B is a front view of the assembled battery using the battery-cell coupling structure according to the other embodiment of the disclosure.

### DETAILED DESCRIPTION

In the battery pack described in JP-A No. 2014-199716, the shapes of the bus bars are changed each time, for example, the number of the battery modules stored in the battery pack, the layout of the battery modules, or the method of coupling the battery modules is changed. This leads to a problem in that it is difficult to reduce the manufacturing cost, such as the die cost for manufacturing the bus bars.

In addition, when the conventional battery pack is used in an apparatus, such as an electric automobile, that uses a large number of battery modules, there are numerous coupling points with bus bars. Hence, the task of coupling the bus bars and the positive and negative electrode terminals by welding or the like is performed many times, making the task complex. Similarly, there also is a task of coupling and fixing the battery modules in the battery pack to one another, making the task complex.

It is desirable to provide a battery-cell coupling structure capable of coupling, in series, parallel, or series-parallel, multiple battery cells arranged at least in one direction with electrode coupling plates having multiple patterns of coupling terminals.

A coupling structure 10 for battery cells 11 according to an embodiment of the disclosure will be described in detail below with reference to the drawings. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description. The top-bottom direction in the drawings corresponds to the thickness direction of the battery cells 11. The left-right direction in the drawings corresponds to the short direction, or the transverse width direction, of the battery cells 11. The front-rear direction in the drawings corresponds to the long direction, or the longitudinal width direction, of the battery cells 11. The left-right direction is the direction in which the battery cells 11 are arranged (arrangement direction) and corresponds to a first direction in the disclosure. The front-rear direction corresponds to a second direction in the disclosure.

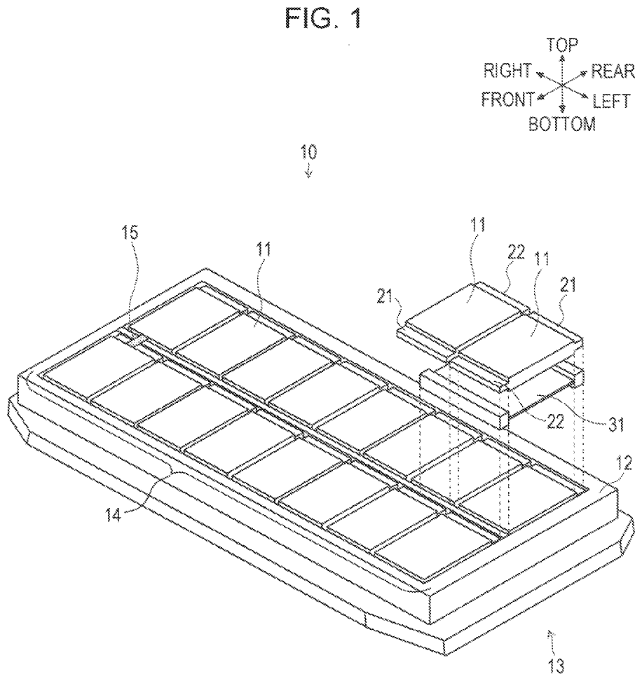

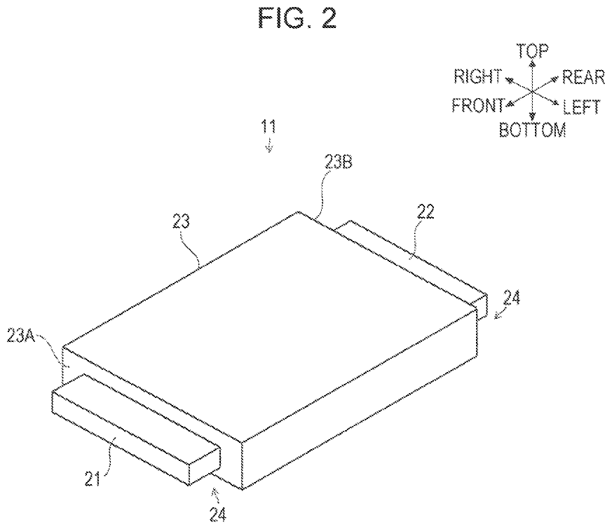

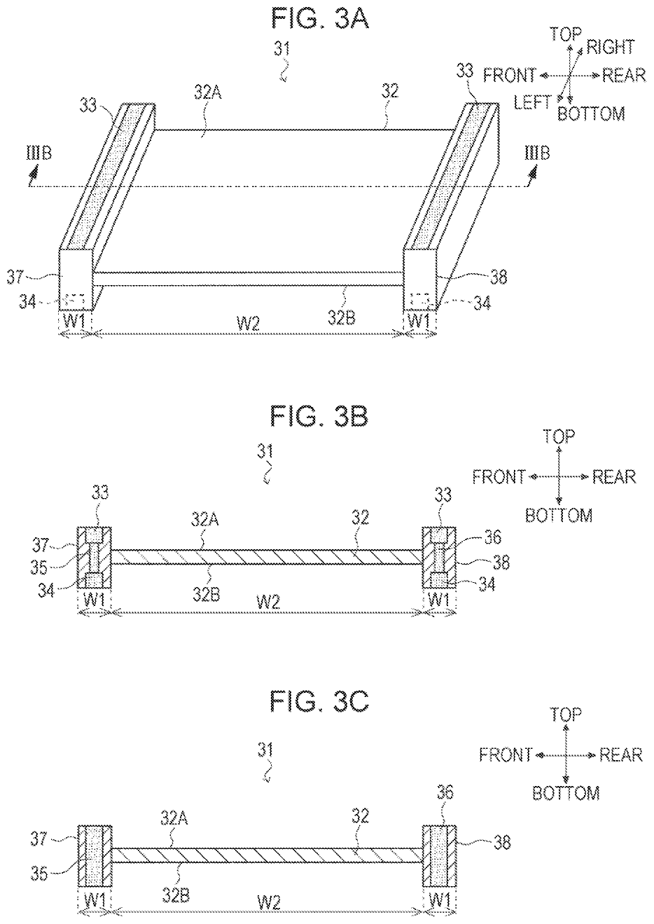

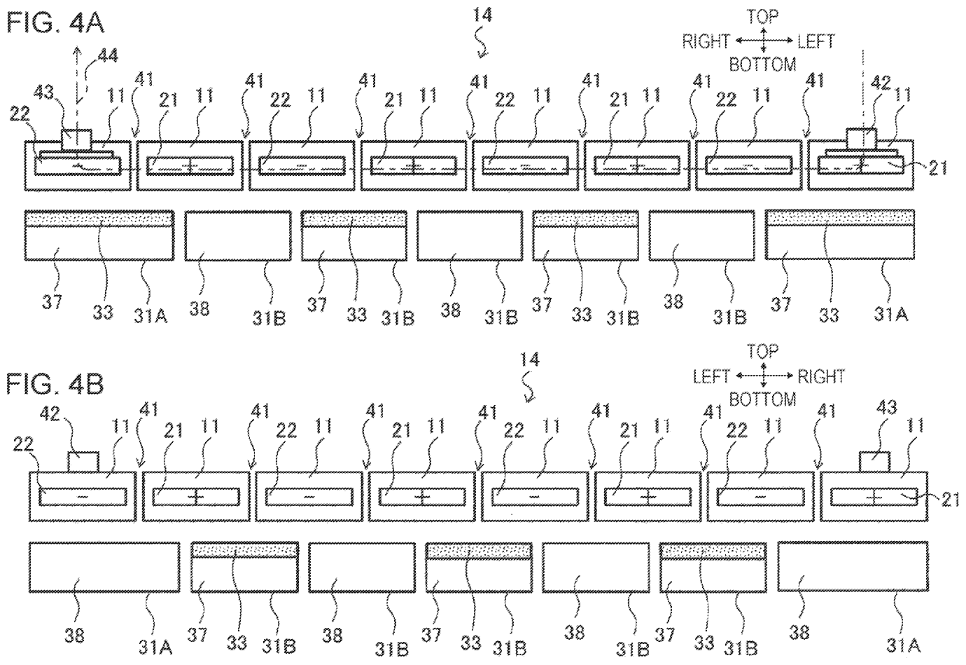

FIG. 1 is a perspective view of a battery pack 13 using the coupling structure 10 for the battery cells 11 according to this embodiment. FIG. 2 is a perspective view of a battery cell 11 used in the coupling structure 10 for the battery cells 11 according to this embodiment. FIG. 3A is a perspective view of an electrode coupling plate 31 used in the coupling structure 10 for the battery cells 11 according to this embodiment. FIG. 3B is a cross-sectional view of the electrode coupling plate 31 illustrated in FIG. 3A, taken along line IIIB-IIIB in FIG. 3A. FIG. 3C is a cross-sectional view of a modification of the electrode coupling plate 31 illustrated in FIG. 3B. FIG. 4A is a front view of an assembled battery 14 using the coupling structure 10 for the battery cells 11 according to this embodiment. FIG. 4B is a back view of the assembled battery 14 using the coupling structure 10 for the battery cells 11 according to this embodiment.

FIG. 1 illustrates the battery pack 13 in which multiple battery cells 11 are stored. For example, a total of sixteen battery cells 11 (two rows of eight battery cells 11) are stored in a battery case 12. As illustrated in FIG. 1, in each row, eight battery cells 11 are arranged in a laid manner in the arrangement direction (left-right direction) and are coupled to one another in series by the electrode coupling plates 31. The sixteen battery cells 11 are disposed in one layer in the height direction (top-bottom direction) of the battery pack 13.

As illustrated in FIG. 1, two assembled batteries 14, each including eight series-coupled battery cells 11, are stored in the battery pack 13. In this case, each assembled battery 14 uses seven electrode coupling plates 31. The electrode coupling plates 31 are disposed so as to straddle boundaries between adjacent battery cells 11 to achieve a series coupling structure of the assembled battery 14. The assembled batteries 14 are coupled to each other in series via a bus bar 15 to form the high-voltage battery pack 13. The assembled batteries 14 are electrically coupled to a battery control unit (BCU) or a junction box, which is an electronic device (not illustrated). The assembled batteries 14 may be coupled to each other in parallel or series-parallel via the bus bars 15 depending on the voltage standard of the battery pack 13.

In this embodiment, the battery cells 11 and the electrode coupling plates 31 are press-fitted into the battery case 12. Positive electrode plates 21 and negative electrode plates 22 of the battery cells 11 are electrically coupled to first coupling terminals 33 (see FIG. 4A) of the electrode coupling plates 31 with a desired contact pressure. As will be described in detail below, every other electrode coupling plate 31 is rotated by 180 degrees in the horizontal direction so that the first coupling terminals 33 are positioned alternately on the front side and the rear side.

With this structure, in the coupling structure 10 for the battery cells 11, the battery cells 11 and the electrode coupling plate 31 can be electrically coupled to one another without using welding or bolt fastening. This simplifies the manufacturing process of the assembled batteries 14, reduces the component count and the materials, and thus reduces the manufacturing cost. Furthermore, in recycling the assembled battery 14, the assembled battery 14 can be disassembled by pulling out the battery cells 11 and other components, without needing to remove welded or bolt-fastened portions. Thus, the work time is significantly reduced.

The coupling structure 10 for the battery cells 11 is not limited to the structure having a press-fitting structure as long as the desired contact pressure is ensured to maintain good electrical coupling. For example, a lid for closing an upper opening of the battery case 12 may be used to press the battery cells 11 and the like from the upper side to the lower side of the battery case 12.

For example, the battery pack 13 is disposed below the floor of a vehicle, such as an automobile or a train, and supplies electric power to a motor and various electrical components. In the field of automobiles, in recent years, electrical vehicles (Evs), hybrid electrical vehicles (HEVs), plug-in hybrid electrical vehicles (PHEVs), and the like have become widespread.

The coupling structure 10 for the battery cells 11 according to this embodiment may be used in a case other than the case where the battery cells 11 constituting the assembled battery 14 are electrically coupled to one another. For example, the coupling structure 10 may also be used to electrically couple individual battery cells 11 directly arranged in the battery case 12 of the battery pack 13 to one another. Besides these cases, the coupling structure 10 for the battery cells 11 according to this embodiment may be used to continuously and electrically couple multiple battery cells 11 arranged at least in the arrangement direction of the multiple battery cells 11 to one another.

As illustrated in FIG. 2, the battery cells 11 are, for example, secondary batteries, such as nickel hydrogen batteries or lithium ion batteries. Each battery cell 11 has, for example, a flat rectangular parallelepiped shape. The positive electrode plate 21 and the negative electrode plate 22 are provided at the opposite ends of the battery cell 11 in the long direction (front-rear direction). The battery cells 11 are not limited to nickel-hydrogen batteries or lithium-ion batteries, and other batteries, such as all-solid-state batteries, that have the positive electrode plate 21 and the negative electrode plate 22 may also be used. The positive electrode plate 21 corresponds to a first electrode of the disclosure, and the negative electrode plate 22 corresponds to a second electrode of the disclosure.

As illustrated in FIG. 2, the positive electrode plate 21 and the negative electrode plate 22 are provided so as to protrude outward from a side surface 23A and a side surface 23B, respectively, of a housing 23 of the battery cell 11. The positive electrode plate 21 and the negative electrode plate 22 have a rectangular shape and extend in the left-right direction. The positive electrode plate 21 and the negative electrode plate 22 are located inward of the outer peripheries of the side surfaces 23A and 23B of the housing 23. Hence, there are steps 24 between the housing 23 and the positive electrode plate 21 and the negative electrode plate 22 at the ends of the battery cell 11 in the long direction.

As illustrated in FIG. 3A, the electrode coupling plate 31 includes an insulating substrate 32, first coupling terminals 33 provided at a side surface 32A, which is a first main surface of the insulating substrate 32, second coupling terminals 34 provided at a side surface 32B, which is a second main surface of the insulating substrate 32, and a third coupling terminal 35 and a fourth coupling terminal 36 (see FIG. 3B) each electrically coupling the first coupling terminal 33 and the second coupling terminal 34 to each other. In principle, the electrode coupling plates 31 are disposed so as to straddle boundaries 41 (see FIG. 4A) between adjacent battery cells 11 in the arrangement direction (left-right direction) of the multiple battery cells 11.

When the battery cells 11 are stacked in two or more layers in the height direction (top-bottom direction) of the battery pack 13, the electrode coupling plates 31 are disposed between the battery cells 11 adjacent to each other in the height direction to also serve as separators.

The insulating substrate 32 is an insulating plate made of, for example, resin, such as a thermosetting resin. As described above, because the electrode coupling plate 31 also serves as the separator, the insulating substrate 32 has substantially the same rectangular shape as the battery cell 11 in plan view. The first coupling terminals 33 and the second coupling terminals 34 are, for example, rectangular columnar bus bars. These bus bars are cut to a length substantially equal to the length of the insulating substrate 32 in the short direction (left-right direction) thereof, and are integrated with the insulating substrate 32 by resin molding. As illustrated in FIGS. 3A and 3B, the first coupling terminals 33 are exposed at the side surface 32A of the insulating substrate 32. The second coupling terminals 34 are exposed at the side surface 32B of the insulating substrate 32. The first coupling terminals 33 and the second coupling terminals 34 are separated from each other by the insulating substrate 32 so as to be electrically decoupled from each other.

With this structure, arrangement regions W1 in the electrode coupling plate 31 where the first coupling terminals 33 and the second coupling terminals 34 are provided are thicker than the remaining part, i.e., a region W2, in the electrode coupling plate 31, and serve as projections 37 and 38. When the electrode coupling plates 31 are disposed so as to straddle the boundaries 41 between the adjacent battery cells 11, the projections 37 and 38 engage with the steps 24 (see FIG. 2) in the battery cells 11. The battery cells 11 fitted between the projections 37 and 38 are prevented from moving in the long direction (front-rear direction) thereof.

As illustrated in FIG. 3B, the third and fourth coupling terminals 35 and 36 are provided at the centers of the projections 37 and 38 in the short direction (left-right direction), respectively. The third and fourth coupling terminals 35 and 36 are rectangular columnar bus bars. The third coupling terminal 35 and the fourth coupling terminal 36 are each coupled to the first coupling terminal 33 and the second coupling terminal 34 to electrically couple the first coupling terminal 33 and the second coupling terminal 34 to each other. In this structure, the third coupling terminal 35 and the fourth coupling terminal 36 serve as wires for electrically coupling the first coupling terminals 33 and the second coupling terminals 34 to each other. The positions of the third and fourth coupling terminals 35 and 36 are not limited to the centers of the projections 37 and 38, and may be any positions in the projections 37 and 38.

Referring to FIG. 3C, illustrating a modification of the electrode coupling plate 31, the third and fourth coupling terminals 35 and 36 may be directly exposed from the side surfaces 32A and 32B at the projections 37 and 38 so as to be used as terminals. The third and fourth coupling terminals 35 and 36 are used to electrically couple the battery cells 11 adjacent to each other in the height direction. The positions of the third and fourth coupling terminals 35 and 36 are not limited to the centers of the projections 37 and 38, and may be any positions in the projections 37 and 38.

As will be described in detail below, in the coupling structure 10 for the battery cells 11 according to this embodiment, multiple patterns of the structure of the electrode coupling plates 31 are formed by the presence, absence, and combination of the first coupling terminal 33, the second coupling terminal 34, the third coupling terminal 35, and the fourth coupling terminal 36 in the projections 37 and 38. In the coupling structure 10 for the battery cells 11, the multiple battery cells 11 are coupled in series, parallel, or series-parallel by appropriately using multiple patterns of the electrode coupling plates 31.

FIGS. 4A and 4B illustrate the coupling structure 10 for the battery cells 11 in the assembled battery 14 illustrated in FIG. 1. The electrode coupling plates 31 include, for example, a first electrode coupling plate 31A having a larger width than the battery cell 11, and a second electrode coupling plate 31B having substantially the same width as the battery cell 11. In FIGS. 4A and 4B, the battery cells 11 and the first and second electrode coupling plates 31A and 31B are illustrated apart from each other for convenience of description. However, in reality, the projections 37 and 38 of the first electrode coupling plates 31A and the second electrode coupling plates 31B are engaged with the steps 24 (see FIG. 2) in the battery cells 11. For convenience of description, the first coupling terminals 33 are illustrated in a manner viewable from the end surfaces of the projections 37 and 38.

As illustrated in FIGS. 4A and 4B, in the coupling structure 10 for the battery cells 11 according to this embodiment, the battery cells 11 are arranged in the left-right direction. In series coupling, the positive electrode plates 21 and the negative electrode plates 22 of the adjacent battery cells 11 are arranged so as to alternate with each other. That is, when the assembled battery 14 is viewed from the front side or the rear side, the positive electrode plates 21 and the negative electrode plates 22 of the battery cells 11 are arranged so as to alternate with each other in the arrangement direction (left-right direction) of the battery cells 11.

In the first electrode coupling plates 31A, the first coupling terminal 33 is provided at the side surface 32A of the projection 37. In the second electrode coupling plates 31B, the first coupling terminal 33 is provided at the side surface 32A of the projection 37.

When the battery cells 11 are coupled in series, the first electrode coupling plates 31A are disposed below the battery cells 11 at both ends in the arrangement direction. The first electrode coupling plates 31A are disposed so as to straddle the boundaries 41 between the adjacent battery cells 11. The second electrode coupling plates 31B are disposed below the battery cells 11 located between the battery cells 11 at both ends in the arrangement direction. The second electrode coupling plates 31B are disposed so as to straddle the boundaries 41 between the adjacent battery cells 11.

At this time, the second electrode coupling plates 31B are arranged such that the projections 37 having the first coupling terminals 33 are positioned alternately on the front side and the rear side. By rotating the second electrode coupling plates 31B by 180 degrees in the horizontal direction to change the positions of the first coupling terminals 33, the second electrode coupling plates 31B can be used in the series coupling.

As illustrated in FIG. 4A, the positive electrode plate 21 of the battery cell 11 that is located on the left side in the assembled battery 14 is coupled to a total positive electrode terminal 42 for output. The negative electrode plate 22 of the battery cell 11 that is located on the right side in the assembled battery 14 is coupled to a total negative electrode terminal 43 for output. As indicated by a one-dot chain line 44, which schematically indicates the flow of a current, in the assembled battery 14, the series coupling structure is achieved with the above-described coupling structure 10 for the battery cells 11. The battery cells 11 are arranged with gaps at the boundaries 41 in the arrangement direction, so that the gaps can be used as passages for cooling air. The assembled battery 14 is not limited to the battery having a single-layer structure, and may have a multilayer structure in which the battery cells 11 are stacked in two or more layers.

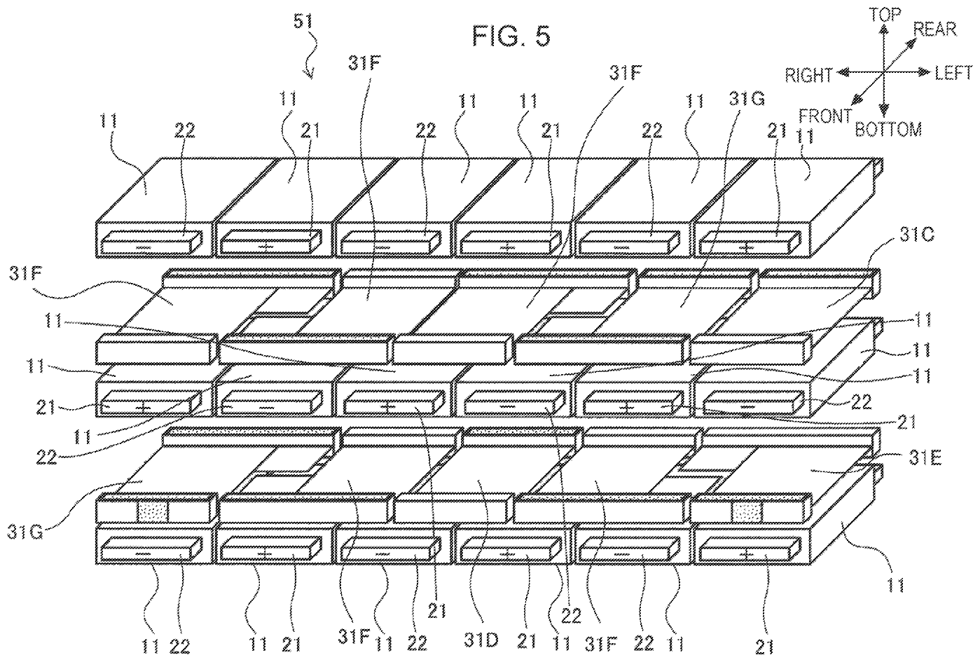

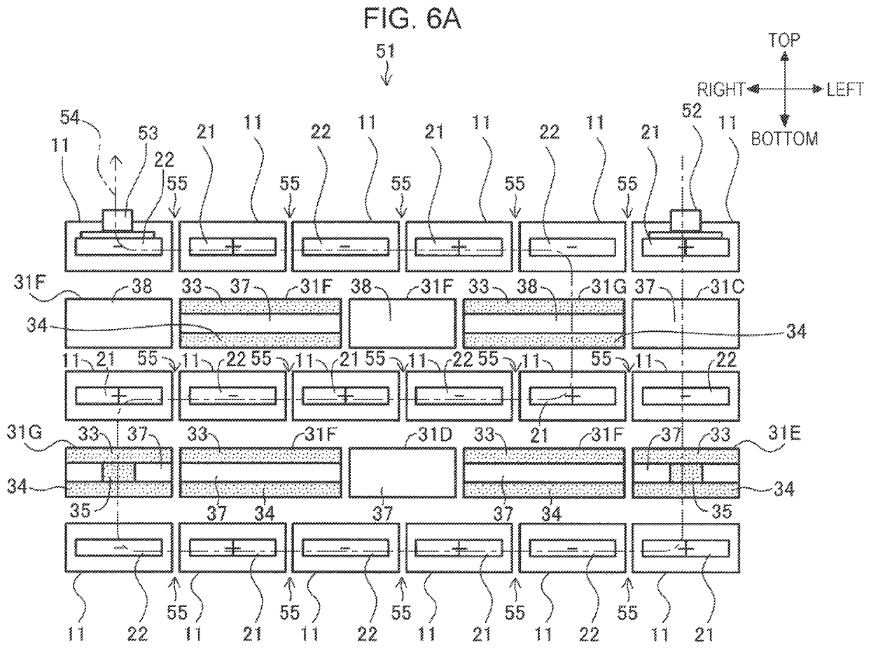

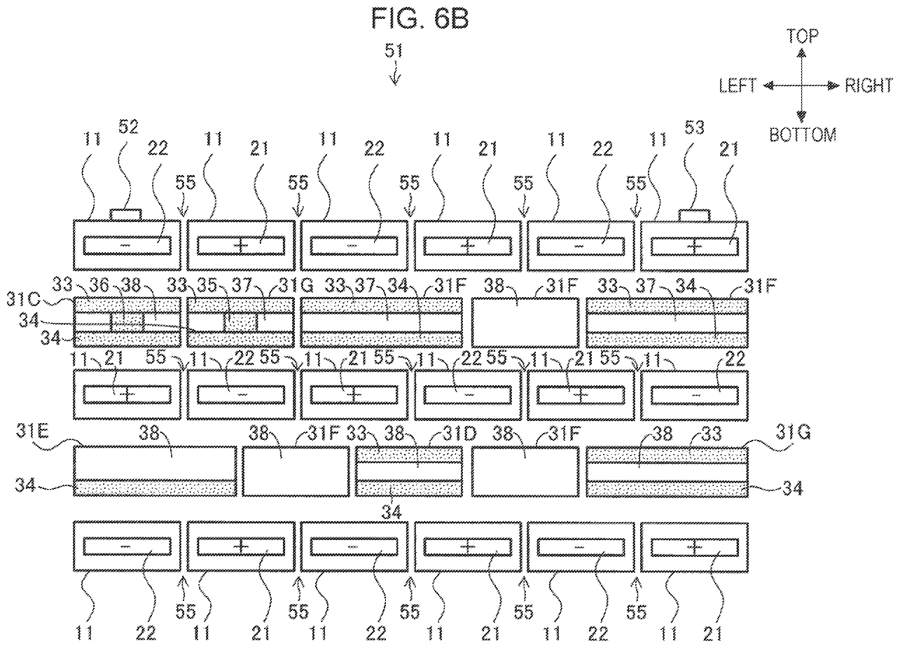

Next, referring to FIGS. 5 to 6B, the structure of an assembled battery 51 having the series coupling structure using the coupling structure 10 for the battery cells 11 according to this embodiment, in which multiple battery cells 11 are stacked in three layers in the height direction of a battery pack (not illustrated), will be described. FIG. 5 is a perspective view of the assembled battery 51 using the coupling structure 10 for the battery cells 11 according to this embodiment. FIG. 6A is a front view of the assembled battery 51 using the coupling structure 10 for the battery cells 11 according to this embodiment. FIG. 6B is a back view of the assembled battery 51 using the Coupling structure 10 for the battery cells 11 according to this embodiment. In the assembled battery 51 according to this embodiment, the multilayer structure of the battery cells 11 is achieved with the electrode coupling plates 31 that are different from those used in the above-described assembled battery 14.

As illustrated in FIGS. 5 to 6B, the electrode coupling plates 31 include, for example, a third electrode coupling plate 31C and a fourth electrode coupling plate 31D having substantially the same width as the battery cell 11, and a fifth electrode coupling plate 31E, a sixth electrode coupling plate 31F, and a seventh electrode coupling plate 31G having a larger width than the battery cell 11 on one side in the front-rear direction and having substantially the same width as the battery cell 11 on the other side in the front-rear direction. In FIGS. 5 to 6B, the battery cells 11 and the third to the seventh electrode coupling plates 31C to 31G are illustrated apart from each other for convenience of description. However, in reality, the projections 37 and 38 of the third to the seventh electrode coupling plates 31C to 31G are engaged with the steps 24 (see FIG. 2) in the battery cells 11. For convenience of description, in FIGS. 6A and 6B, the first to the fourth coupling terminals 33 to 36 are illustrated in a manner viewable from the end surfaces of the projections 37 and 38.

FIG. 5 illustrates one assembled battery 51 to be stored in a battery pack (not illustrated). In the assembled battery 51, for example, six battery cells 11 arranged in the arrangement direction (left-right direction) are stacked in three layers in the height direction (top-bottom direction) of the battery pack. As illustrated in FIG. 1, multiple assembled batteries 51 may be stored in the battery pack and coupled in series via a bus bar (not illustrated) to achieve a high voltage. Alternatively, the assembled batteries 51 may be coupled to each other in parallel or series-parallel via bus bars depending on the voltage standard of the battery pack.

As illustrated in FIG. 5, the positive electrode plates 21 and the negative electrode plates 22 of the adjacent battery cells 11 are arranged so as to alternate with each other in the arrangement direction in each layer. Also in the height direction of the battery cells 11, the positive electrode plates 21 and the negative electrode plates 22 of the adjacent battery cells 11 are arranged so as to alternate with each other.

That is, as illustrated in FIGS. 6A and 6B, when the assembled battery 51 is viewed from the front side or the rear side, the positive electrode plates 21 and the negative electrode plates 22 of the battery cells 11 are arranged so as to alternate with each other both in the arrangement direction and the height direction of the assembled battery 51.

In the third electrode coupling plate 31C, the first coupling terminal 33, the second coupling terminal 34, and the fourth coupling terminal 36 are provided at the projection 38. In the fourth electrode coupling plate 31D, the first coupling terminal 33 and the second coupling terminal 34 are provided at the projection 38. In the fifth electrode coupling plate 31E, the first coupling terminal 33, the second coupling terminal 34, and the third coupling terminal 35 are provided at the projection 37, and the second coupling terminal 34 is provided at the projection 38. In the sixth electrode coupling plate 31F, the first coupling terminal 33 and the second coupling terminal 34 are provided at the projection 37. In the seventh electrode coupling plate 31G, the first coupling terminal 33, the second coupling terminal 34, and the third coupling terminal 35 are provided at the projection 37, and the first coupling terminal 33 and the second coupling terminal 34 are provided at the projection 38. The sixth electrode coupling plate 31F and the seventh electrode coupling plate 31G may be used in a manner rotated by 180 degrees in the horizontal direction as appropriate.

As illustrated in FIGS. 6A and 6B, the third to the seventh electrode coupling plates 31C to 31G used in the assembled battery 51 are disposed between the first and second layers of the battery cells 11 and between the second and third layers of the battery cells 11. The fourth to the seventh electrode coupling plates 31D to 31G are disposed so as to at least partially straddle boundaries 55 between the battery cells 11 adjacent to each other in the arrangement direction. The third electrode coupling plate 31C electrically couples the battery cells 11 adjacent to each other in the height direction and is disposed so as not to straddle the boundary 55 between the battery cells 11 adjacent to each other in the arrangement direction.

The positive electrode plate 21 of the battery cell 11 that is located on the left side in the third layer of the assembled battery 51 is coupled to a total positive electrode terminal 52 for output. The negative electrode plate 22 of the battery cell 11 that is located on the right side in the third layer of the assembled battery 51 is coupled to a total negative electrode terminal 53 for output. As indicated by a one-dot chain line 54, which schematically indicates the flow of a current, in the assembled battery 51, the series coupling structure is achieved with the above-described coupling structure 10 for the battery cells 11. The battery cells 11 are arranged with gaps at the boundaries 55 in the arrangement direction (left-right direction), so that the gaps can be used as passages for cooling air.

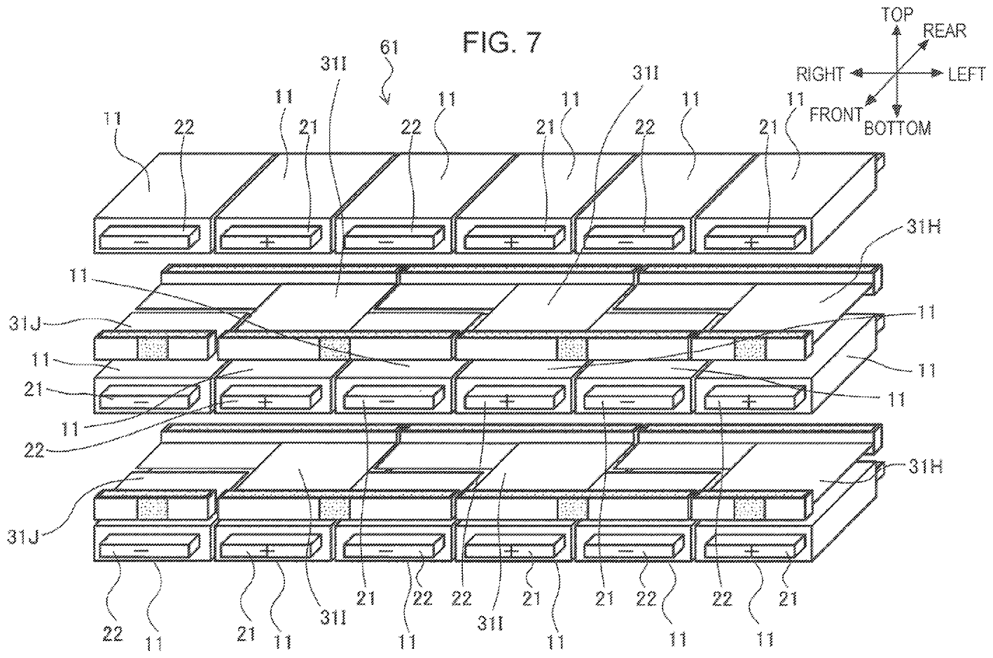

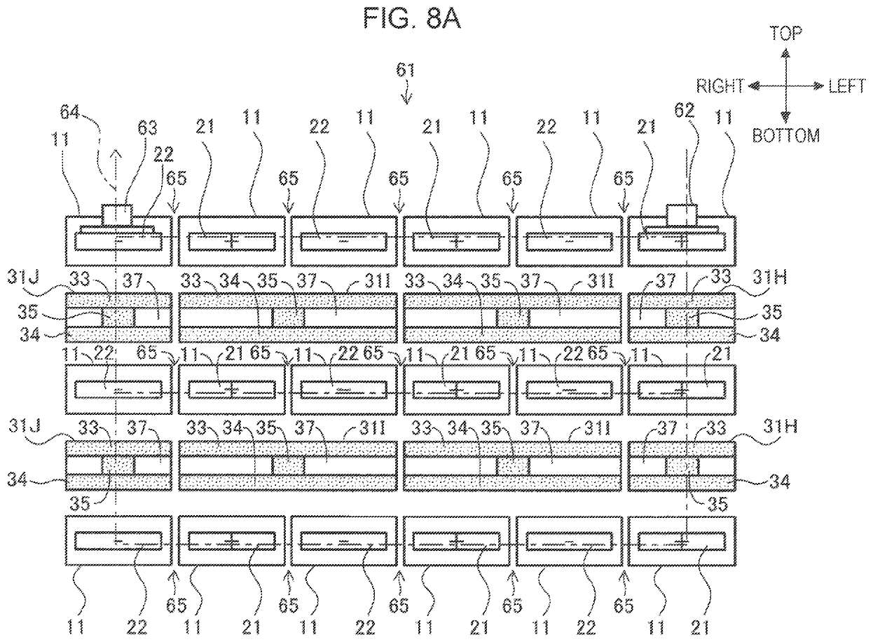

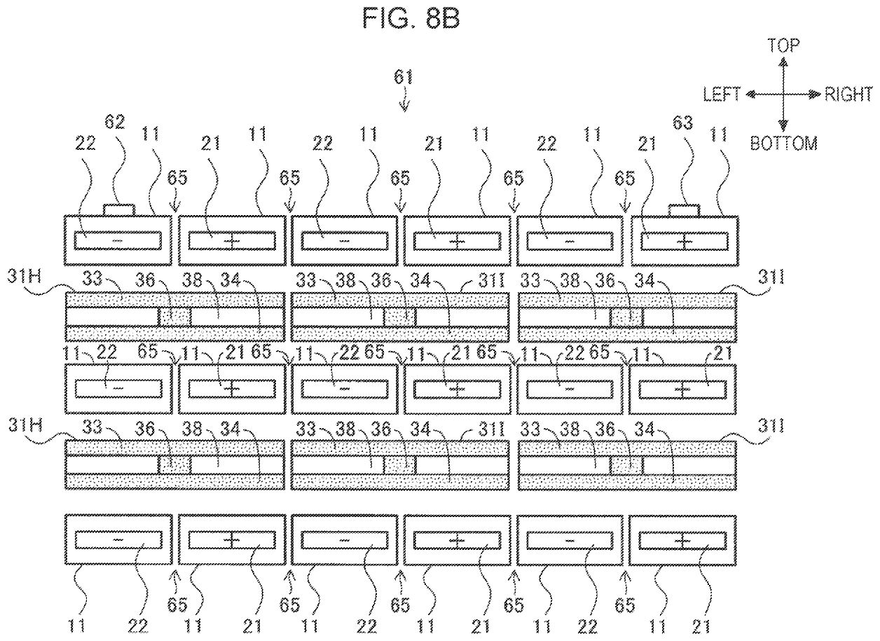

Next, referring to FIGS. 7 to 8B, the structure of an assembled battery 61 having a series-parallel coupling structure using the coupling structure 10 for the battery cells 11 according to this embodiment, in which multiple battery cells 11 are stacked in three layers in the height direction of a battery pack (not illustrated), will be described. FIG. 7 is a perspective view of the assembled battery 61 using the coupling structure 10 for the battery cells 11 according to this embodiment. FIG. 8A is a front view of the assembled battery 61 using the coupling structure 10 for the battery cells 11 according to this embodiment. FIG. 8B is a back view of the assembled battery 61 using the coupling structure 10 for the battery cells 11 according to this embodiment.

As illustrated in FIGS. 7 to 8B, the electrode coupling plates 31 include, for example, an eighth electrode coupling plate 31H having a larger width than the battery cell 11 on one side in the front-rear direction and having substantially the same width as the battery cell 11 on the other side in the front-rear direction, a ninth electrode coupling plate 31I having a larger width than the battery cell 11 on both sides in the front-rear direction, and a tenth electrode coupling plate 31J having the projection 37 alone, which has substantially the same width as the battery cells 11, on one side. In FIGS. 7 to 8B, the battery cells 11 and the eighth to the tenth electrode coupling plates 31H to 31J are illustrated apart from each other for convenience of description. However, in reality, the projections 37 and 38 of the eighth to the tenth electrode coupling plates 31H to 31J are engaged with the steps 24 (see FIG. 2) in the battery cells 11.

FIG. 7 illustrates one assembled battery 61 to be stored in a battery pack (not illustrated). In the assembled battery 61, for example, six battery cells 11 arranged in the arrangement direction (left-right direction) are stacked in three layers in the height direction (top-bottom direction) of the battery pack. As illustrated in FIG. 1, multiple assembled batteries 61 may be stored in the battery pack and coupled in series via a bus bar (not illustrated) to achieve a high voltage. Alternatively, the assembled batteries 61 may be coupled to each other in parallel or series-parallel via bus bars depending on the voltage standard of the battery pack.

As illustrated in FIG. 7, the positive electrode plates 21 and the negative electrode plates 22 of the adjacent battery cells 11 are arranged so as to alternate with each other in the arrangement direction in each layer. In the height direction of the battery cells 11, the positive electrode plates 21 and the negative electrode plates 22 are respectively arranged on the same type of electrode plates. That is, as illustrated in FIGS. 8A and 8B, in the assembled battery 61, the battery cells 11 adjacent to each other in the height direction are coupled in parallel, and the groups of the battery cells 11 coupled in parallel are coupled in series in the arrangement direction.

In the eighth electrode coupling plate 31H and the ninth electrode coupling plate 31I, the first coupling terminal 33, the second coupling terminal 34, and the third coupling terminal 35 are provided at the projection 37, and the first coupling terminal 33, the second coupling terminal 34, and the fourth coupling terminal 36 are provided at the projection 38. In the tenth electrode coupling plate 31J, the first coupling terminal 33, the second coupling terminal 34, and the third coupling terminal 35 are provided at the projection 37. The tenth electrode coupling plate 31J is provided of an insulating substrate 32 having about half the length of the other insulating substrates 32 in the long direction (front-rear direction), and thus cannot be viewed from the rear side of the assembled battery 61.

As illustrated in FIGS. 8A and 8B, the eighth to the tenth electrode coupling plates 31H to 31J used in the assembled battery 61 are disposed between the first and second layers of the battery cells 11 and between the second and third layers of the battery cells 11. The eighth and the ninth electrode coupling plates 31H and 31I are disposed so as to at least partially straddle boundaries 65 between the battery cells 11 adjacent to each other in the arrangement direction. The tenth electrode coupling plate 31J electrically couples the battery cells 11 adjacent to each other in the height direction and is disposed so as not to straddle the boundary 65 between the battery cells 11 adjacent to each other in the arrangement direction.

The positive electrode plate 21 of the battery cell 11 that is located on the left side in the third layer of the assembled battery 61 is coupled to a total positive electrode terminal 62 for output. The negative electrode plate 22 of the battery cell 11 that is located on the right side in the third layer of the assembled battery 61 is coupled to a total negative electrode terminal 63 for output. As indicated by a one-dot chain line 64, which schematically indicates the flow of a current, in the assembled battery 61, the series-parallel coupling structure is achieved with the above-described coupling structure 10 for the battery cells 11. The battery cells 11 are arranged with gaps at the boundaries 65 in the arrangement direction (left-right direction), so that the gaps can be used as passages for cooling air.

As described above, the coupling structure 10 for the battery cells 11 achieves the series, parallel, or series-parallel coupling structure with one type of battery cells 11 and multiple types of electrode coupling plates 31. The facility for manufacturing the battery cells 11 is usually expensive, and thus if multiple electrode shapes are used for the battery cells, the manufacturing cost of the battery cells 11 is significantly high. However, the use of multiple types of electrode coupling plates 31 enables the use of one type of battery cells 11. Thus, the manufacturing cost is significantly reduced.

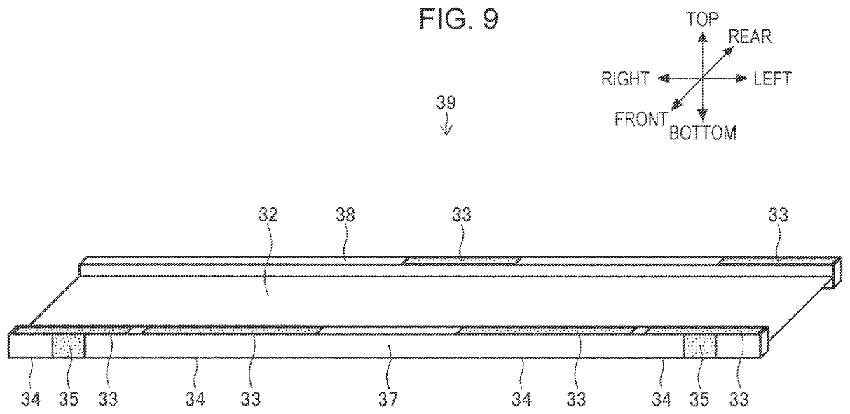

In the coupling structure 10 for the battery cells 11 according to this embodiment illustrated in FIG. 5, five electrode coupling plates 31, namely, from the left side, the fifth electrode coupling plate 31E, the sixth electrode coupling plate 31F, the fourth electrode coupling plate 31D, the sixth electrode coupling plate 31F, and the seventh electrode coupling plate 31G, are disposed between the first and second layers of the battery cells 11. However, the disclosure is not limited to this case. For example, the coupling structure 10 for the battery cells 11 may be achieved with an electrode coupling plate 39 illustrated in FIG. 9.

FIG. 9 is a perspective view of the electrode coupling plate 39 used in the coupling structure 10 for the battery cells 11 according to this embodiment. As illustrated in FIG. 9, the insulating substrate 32 constituting the electrode coupling plate 39 is large enough to correspond to six battery cells 11 arranged in the arrangement direction (left-right direction). The insulating substrate 32 has the projections 37 and 38 at opposite ends in the front-rear direction. Similarly to the insulating substrate 32, the projections 37 and 38 are also long enough to correspond to six battery cells 11 arranged in the arrangement direction (left-right direction).

As illustrated in FIG. 9, in the electrode coupling plate 39, the first coupling terminal 33, the second coupling terminal 34, the third coupling terminal 35, and the fourth coupling terminal 36 are disposed in the projections 37 and 38 of the single insulating substrate 32, at positions illustrated in FIG. 5. This structure allows the insulating substrate 32 constituting the electrode coupling plate 39 to have a uniform structure, which reduces the number of molds for molding the electrode coupling plates 39. Thus, the manufacturing cost is significantly reduced.

In the coupling structure 10 for the battery cells 11 according to this embodiment, the case has been described where the total positive electrode terminal 62 of the assembled battery 61 is coupled to the battery cell 11 on the left side in the third row, and the total negative electrode terminal 63 of the assembled battery 61 is coupled to the battery cell 11 on the right side in the third row. However, the disclosure is not limited to this case. For example, the total positive electrode terminal 62 and the total negative electrode terminal 63 may be disposed at positions close to each other by changing the arrangement of the electrode coupling plates 31. In other words, the positions of the total positive electrode terminal 62 and the total negative electrode terminal 63 can be changed as desired. By disposing the total positive electrode terminal 62 and the total negative electrode terminal 63 at positions close to each other, various advantages, such as elimination of the need for long bus bars and prevention of a short circuit at the time of collision, are obtained according to the purpose of design. The same advantages are obtained with the assembled batteries 14 and 51. Various other modifications can be made without departing from the gist of the disclosure.

Next, a coupling structure 70 for the battery cells 11 according to another embodiment of the disclosure will be described in detail with reference to the drawings. In the description of this embodiment, the same reference signs basically denote the same members, and repeated descriptions will be omitted. The top-bottom direction in the drawings corresponds to the thickness direction of the battery cells 11. The left-right direction in the drawings is the long direction of the battery cells 11, which corresponds to the longitudinal width direction of the battery cells 11. The front-rear direction in the drawings corresponds to the short direction, or the transverse width direction, of the battery cells 11. The left-right direction is the direction in which the battery cells 11 are arranged (arrangement direction) and corresponds to a first direction in the disclosure.

The coupling structure 70 for the battery cells 11 according to this embodiment differs from the coupling structure 10 for the battery cells 11 described above with reference to FIGS. 1 to 8B mainly in the arrangement direction of the battery cells 11. Consequently, the structure of electrode coupling plates 71, and the shapes and positions of the first coupling terminal 72 to the fourth coupling terminal 75 in the electrode coupling plate 71 are different. In the description of the coupling structure 70 for the battery cells 11, the structures different from those of the above-described coupling structure 10 for the battery cells 11 will be mainly described. The same reference signs denote the same components as those of the coupling structure 10 for the battery cells 11 described above, and repeated description will be omitted.

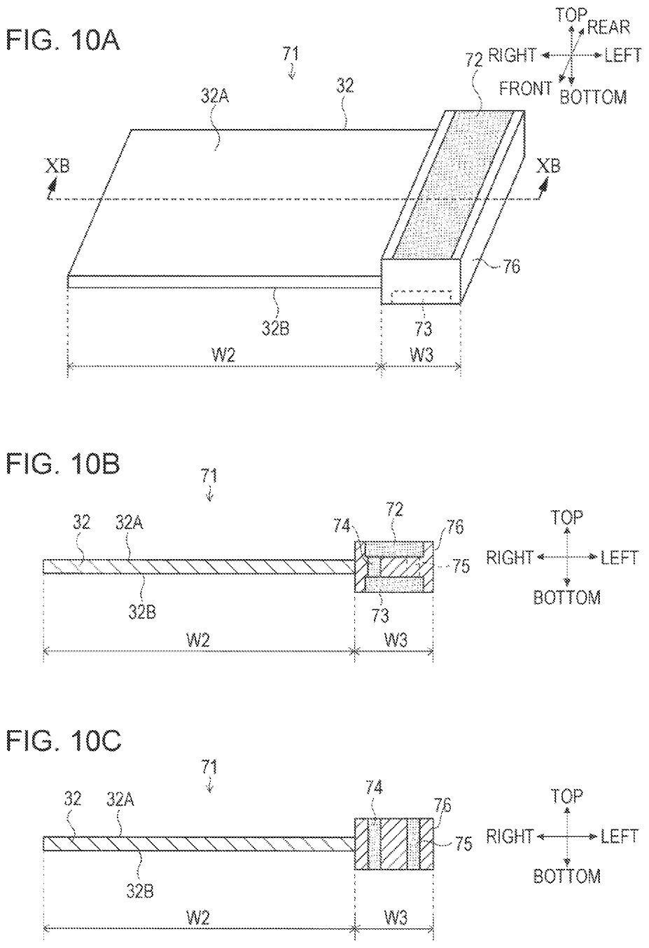

FIG. 10A is a perspective view of the electrode coupling plate 71 used in the coupling structure 70 for the battery cells 11 according to this embodiment. FIG. 10B is a cross-sectional view of the electrode coupling plate 71 illustrated in FIG. 10A, taken along line XB-XB in FIG. 10A. FIG. 10C is a cross-sectional view of a modification of the electrode coupling plate 71 illustrated in FIG. 10B.

As illustrated in FIG. 10A, the electrode coupling plate 71 includes the insulating substrate 32, a first coupling terminal 72 provided at the side surface 32A, which is the first main surface of the insulating substrate 32, a second coupling terminal 73 provided at the side surface 32B, which is the second main surface of the insulating substrate 32, and a third coupling terminal 74 (see FIG. 10B) or a fourth coupling terminal 75 (see FIG. 10C) electrically coupling the first coupling terminal 72 and the second coupling terminal 73 to each other. In principle, the electrode coupling plates 71 are disposed so as to straddle boundaries between adjacent battery cells 11 in the arrangement direction (left-right direction) of the multiple battery cells 11.

When the battery cells 11 are stacked in two or more layers in the height direction (top-bottom direction) of the battery pack (not illustrated), the electrode coupling plates 71 are disposed between the battery cells 11 adjacent to each other in the height direction to also serve as separators.

As described above, because the electrode coupling plate 71 also serves as the separator, the insulating substrate 32 has substantially the same rectangular shape as the battery cell 11 in plan view. The first coupling terminal 72 and the second coupling terminal 73 are, for example, rectangular columnar bus bars. These bus bars are cut to a length substantially equal to the length of the insulating substrate 32 in the short direction (front-rear direction) thereof, and are integrated with the insulating substrate 32 by resin molding. As illustrated in FIG. 10A, the first coupling terminal 72 is exposed at the side surface 32A of the insulating substrate 32. The second coupling terminal 73 is exposed at the side surface 32B of the insulating substrate 32. The first coupling terminal 72 and the second coupling terminal 73 are separated from each other by the insulating substrate 32 so as to be electrically decoupled from each other.

As illustrated in FIGS. 10A to 10C, an arrangement region W3 in the electrode coupling plate 71 where the first coupling terminal 72 and the second coupling terminal 73 are provided is thicker than the remaining part, i.e., a region W2, in the electrode coupling plate 71, and serves as a projection 76. In principle, the projection 76 is provided only on one side of the electrode coupling plate 71 in the long direction (left-right direction). As will be described in detail below, because the projection 76 fits between the steps 24 of adjacent battery cells 11, the arrangement region W3 corresponding to the projection 76 has a length substantially twice the arrangement region W1 corresponding to the projection 38 of the electrode coupling plate 31.

With this structure, not only the electrode coupling plates 71, but also the first coupling terminals 72 and the second coupling terminals 73 are disposed so as to straddle boundaries between adjacent battery cells 11 in the arrangement direction (left-right direction).

As illustrated in FIG. 10B, the third coupling terminal 74 and the fourth coupling terminal 75 are provided at the center of the projection 76 in the short direction (front-rear direction). The third coupling terminal 74 and the fourth coupling terminal 75 are rectangular columnar bus bars. The third coupling terminal 74 and the fourth coupling terminal 75 are coupled to the first coupling terminal 72 and second coupling terminal 73 to electrically couple the first coupling terminal 72 and the second coupling terminal 73 to each other. In this structure, the third coupling terminal 74 and the fourth coupling terminal 75 serve as wires for electrically coupling the first coupling terminal 72 and the second coupling terminal 73 to each other.

As illustrated in FIG. 10B, when the third coupling terminal 74 and the fourth coupling terminal 75 serve as the wires, one or both of the third coupling terminal 74 and the fourth coupling terminal 75 may be provided. When one or both of the third coupling terminal 74 and the fourth coupling terminal 75 are provided, the third coupling terminal 74 or the fourth coupling terminal 75 may be disposed at any position in the projection 76.

Meanwhile, as illustrated in FIG. 10C, in the modification of the electrode coupling plate 71, the first coupling terminal 72 and the second coupling terminal 73 are not provided at the projection 76. The third coupling terminal 74 and the fourth coupling terminal 75 may be directly exposed from the side surfaces 32A and 32B of the projection 76 so as to be used as terminals. In this case, the third coupling terminal 74 and the fourth coupling terminal 75 are used to electrically couple the battery cells 11 adjacent to each other in the height direction. Therefore, the third coupling terminal 74 is provided to the right of the boundary between adjacent battery cells 11, and the fourth coupling terminal 75 is provided to the left of the boundary between the adjacent battery cells 11.

As will be described in detail below, in the coupling structure 70 for the battery cells 11 according to this embodiment, multiple patterns of the structure of the electrode coupling plates 71 are formed by the presence, absence, and combination of the first coupling terminal 72, the second coupling terminal 73, the third coupling terminal 74, and the fourth coupling terminal 75 in the projection 76. In the coupling structure 70 for the battery cells 11, by appropriately using multiple patterns of the electrode coupling plates 71, the multiple battery cells 11 are coupled in series, parallel, or series-parallel.

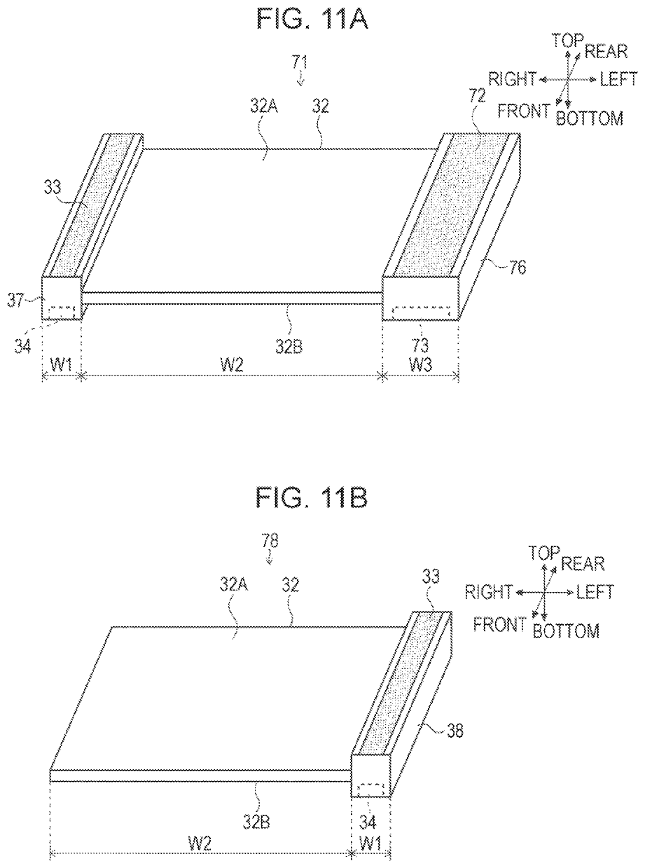

As illustrated in FIG. 11A, an electrode coupling plate 77, which is a modification of the electrode coupling plate 71, may be used. In the electrode coupling plate 77, the projection 37 of the electrode coupling plate 31 is provided at the right end of the electrode coupling plate 71. As described above, the projection 37 is provided with any or a combination of the first coupling terminal 33, the second coupling terminal 34, and the third coupling terminal 35.

As illustrated in FIG. 11B, an electrode coupling plate 78, which is a modification of the electrode coupling plate 71, may be used. The electrode coupling plate 78 does not have the projection 37 of the electrode coupling plate 31, but has the projection 38. As described above, the projection 38 is provided with any or a combination of the first coupling terminal 33, the second coupling terminal 34, and the fourth coupling terminal 36.

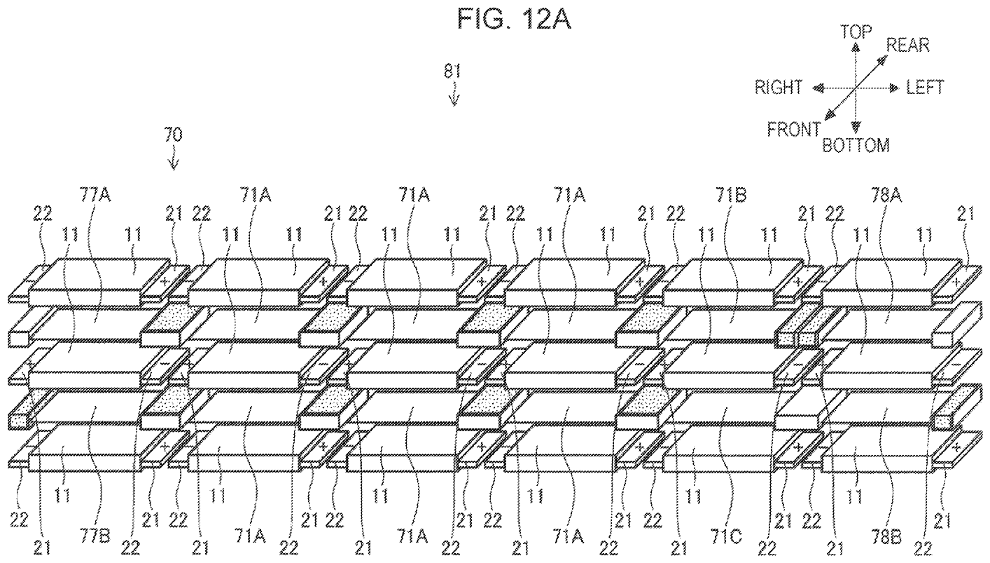

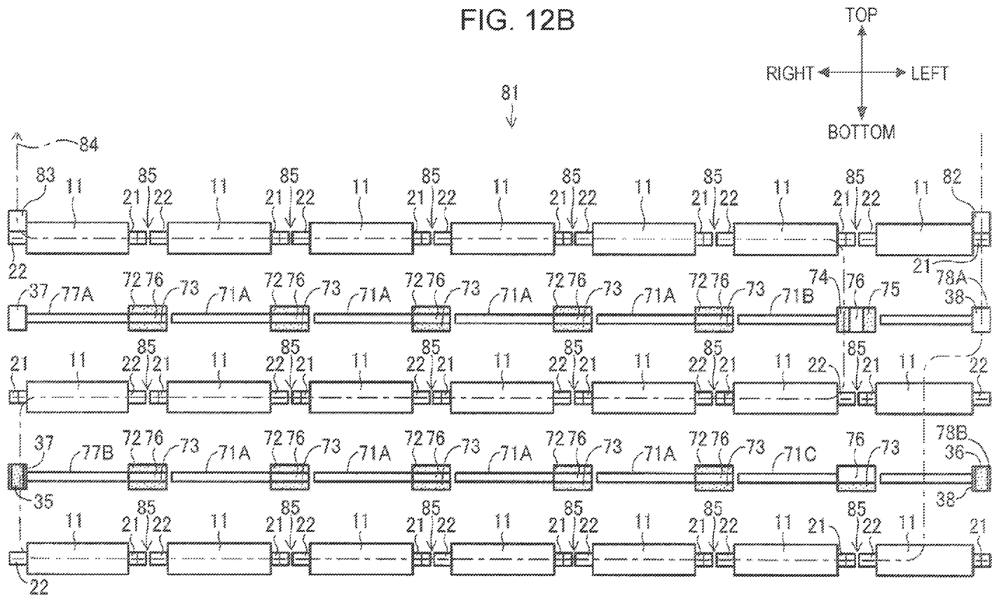

Next, referring to FIGS. 12A and 12B, the structure of an assembled battery 81 having a series coupling structure using the coupling structure 70 for the battery cells 11 according to this embodiment, in which multiple battery cells 11 are stacked in three layers in the height direction of a battery pack (not illustrated), will be described. FIG. 12A is a perspective view of the assembled battery 81 using the coupling structure 70 for the battery cells 11 according to this embodiment. FIG. 12B is a front view of the assembled battery 81 using the coupling structure 70 for the battery cells 11 according to this embodiment.

As illustrated in FIGS. 12A and 12B, the assembled battery 81 includes, for example: a first electrode coupling plate 71A, a second electrode coupling plate 71B, and a third electrode coupling plate 71C having the same shape as the electrode coupling plate 71 (see FIG. 10A); a fourth electrode coupling plate 77A and a fifth electrode coupling plate 77B having the same shape as the electrode coupling plate 77 (see FIG. 11A); and a sixth electrode coupling plate 78A and a seventh electrode coupling plate 78B having the same shape as the electrode coupling plate 78 (see FIG. 11B). In FIGS. 12A and 12B, the battery cells 11 and the first to the seventh electrode coupling plates 71A to 78B are illustrated apart from each other for convenience of description. However, in reality, the projections 37, 38, and 76 of the first to the seventh electrode coupling plates 71A to 78B are engaged with the steps 24 (see FIG. 2) in the battery cells 11.

FIG. 12A illustrates one assembled battery 81 to be stored in a battery pack (not illustrated). In the assembled battery 81, for example, six battery cells 11 are arranged in the arrangement direction (left-right direction) in each layer, and the long direction (left-right direction) of the battery cells 11 coincides with the arrangement direction. The six battery cells 11 in one layer are stacked in three layers in the height direction of the battery pack (top-bottom direction). As illustrated in FIG. 1, multiple assembled batteries 81 may be stored in the battery pack and coupled in series via a bus bar (not illustrated) to achieve a high voltage. Alternatively, the assembled batteries 81 may be coupled to each other in parallel or series-parallel via bus bars depending on the voltage standard of the battery pack.

As illustrated in FIGS. 12A and 12B, the positive electrode plates 21 and the negative electrode plates 22 of the adjacent battery cells 11 are disposed so as to face each other in the arrangement direction in each layer. In the height direction, the orientations of the positive electrode plates 21 and the negative electrode plates 22 of the battery cells 11 are reversed between the even-numbered layer and the odd-numbered layers to achieve a series coupling structure.

In the first electrode coupling plate 71A, the first coupling terminal 72 and the second coupling terminal 73 are provided at the projection 76. In the second electrode coupling plate 71B, the third coupling terminal 74 and the fourth coupling terminal 75 are provided at the projection 76. In the third electrode coupling plate 71C, the second coupling terminal 73 is provided at the projection 76. In the fourth electrode coupling plate 77A, the first terminal 72 and the second coupling terminal 73 are provided at the projection 76. In the fifth electrode coupling plate 77B, the third coupling terminal 35 is provided at the projection 37, and the first coupling terminal 72 and the second coupling terminal 73 are provided at the projection 76. The sixth electrode coupling plate 78A has no coupling terminals. In the seventh electrode coupling plate 78B, the fourth coupling terminal 36 is provided at the projection 38.

As illustrated in FIGS. 12A and 12B, the first to the seventh electrode coupling plates 71A to 78B used in the assembled battery 81 are disposed between the first and second layers of the battery cells 11 and between the second and third layers of the battery cells 11. The first to the fifth electrode coupling plates 71A to 77B are disposed so as to at least partially straddle boundaries 85 between the battery cells 11 adjacent to each other in the arrangement direction. The sixth and seventh electrode coupling plates 78A and 78B are disposed so as not to straddle the boundaries 85 between the battery cells 11 adjacent to each other in the arrangement direction.

The positive electrode plate 21 of the battery cell 11 that is located on the left side in the third layer of the assembled battery 81 is coupled to a total positive electrode terminal 82 for output. The negative electrode plate 22 of the battery cell 11 that is located on the right side in the third layer of the assembled battery 81 is coupled to a total negative electrode terminal 83 for output. As indicated by a one-dot chain line 84, which schematically indicates the flow of a current, in the assembled battery 81, the series coupling structure is achieved with the above-described coupling structure 70 for the battery cells 11. The battery cells 11 are arranged with gaps at the boundaries 85 in the arrangement direction (left-right direction), so that the gaps can be used as passages for cooling air.

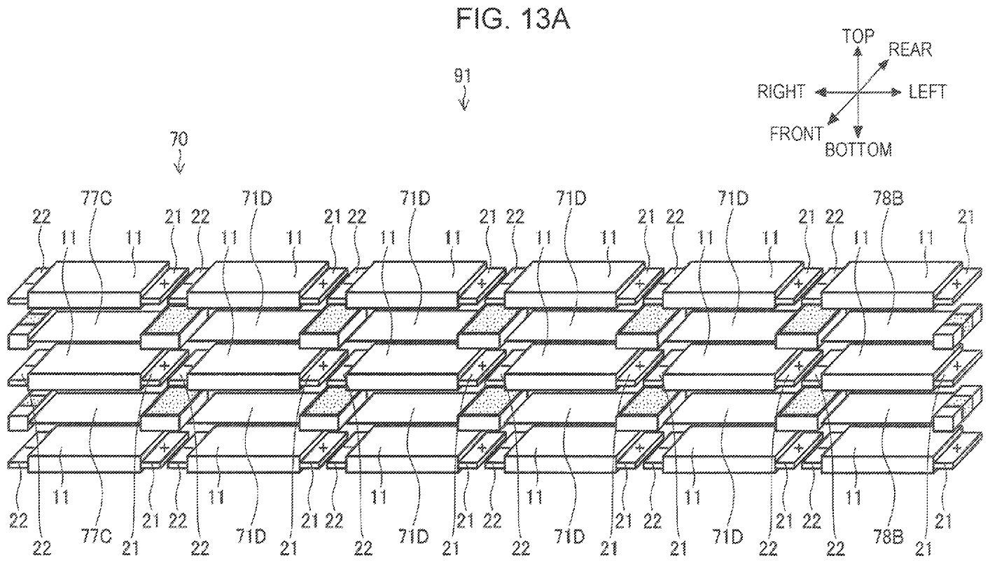

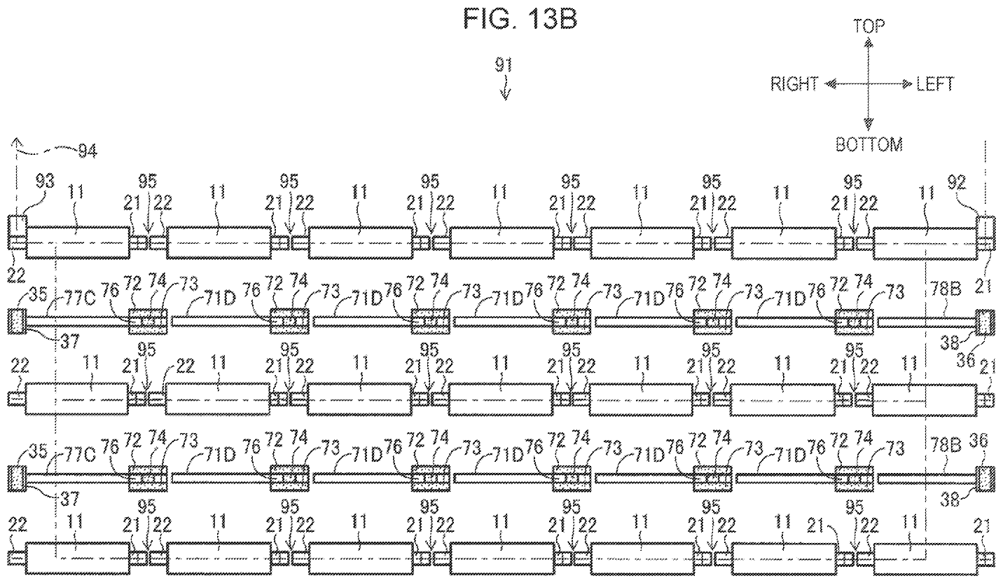

Next, referring to FIGS. 13A and 13B, the structure of an assembled battery 91 having a series-parallel coupling structure using the coupling structure 70 for the battery cells 11 according to this embodiment, in which multiple battery cells 11 are stacked in three layers in the height direction of a battery pack (not illustrated), will be described. FIG. 13A is a perspective view of the assembled battery 91 using the coupling structure 70 for the battery cells 11 according to this embodiment. FIG. 13B is a front view of the assembled battery 91 using the coupling structure 70 for the battery cells 11 according to this embodiment.

As illustrated in FIGS. 13A and 13B, the assembled battery 91 includes, for example, an eighth electrode coupling plate 71D having the same shape as the electrode coupling plate 71 (see FIG. 10A), a ninth electrode coupling plate 77C having the same shape as the electrode coupling plate 77 (see FIG. 11A), and a seventh electrode coupling plate 78B having the same shape as the electrode coupling plate 78 (see FIG. 11B). In FIGS. 13A and 13B, the battery cells 11 and the eighth, ninth, and seventh electrode coupling plates 71D, 77C, and 78B are illustrated apart from each other for convenience of description. However, the projections 37, 38, and 76 of the eighth, ninth, and seventh electrode coupling plates 71D, 77C, and 78B are engaged with the steps 24 (see FIG. 2) in the battery cells 11.

FIG. 13A illustrates one assembled battery 91 to be stored in a battery pack (not illustrated). In the assembled battery 91, for example, six battery cells 11 are arranged in the arrangement direction (left-right direction) in each layer, and the long direction (left-right direction) of the battery cells 11 coincides with the arrangement direction. The six battery cells 11 in one layer are stacked in three layers in the height direction of the battery pack (top-bottom direction). As illustrated in FIG. 1, multiple assembled batteries 91 may be stored in the battery pack and coupled in series via a bus bar (not illustrated) to achieve a high voltage. Alternatively, the assembled batteries 91 may be coupled to each other in parallel or series-parallel via bus bars depending on the voltage standard of the battery pack.

As illustrated in FIGS. 12A and 12B, the positive electrode plates 21 and the negative electrode plates 22 of the adjacent battery cells 11 are disposed so as to face each other in the arrangement direction in each layer. That is, in each of the battery cells 11, the positive electrode plate 21 is disposed on the left side and the negative electrode plate 22 is disposed on the right side to achieve the series-parallel coupling structure.

In the eighth electrode coupling plate 71D, the first coupling terminal 72, the second coupling terminal 73, and the third coupling terminal 74 are provided at the projection 76. In the ninth electrode coupling plate 77C, the first coupling terminal 72, the second coupling terminal 73, and the third coupling terminal 74 are provided at the projection 76, and the third coupling terminal 35 is provided at the projection 37. In the seventh electrode coupling plate 78B, the fourth coupling terminal 36 is provided at the projection 38.

As illustrated in FIGS. 13A and 13B, the eighth, ninth, and seventh electrode coupling plates 71D, 77C, and 78B used in the assembled battery 91 are disposed between the first and second layers of the battery cells 11 and between the second and third layers of the battery cells 11. The eighth and the ninth electrode coupling plates 71D and 77C are disposed so as to at least partially straddle boundaries 95 between the battery cells 11 adjacent to each other in the arrangement direction. The seventh electrode coupling plate 78B is disposed so as not to straddle the boundary 95 between the battery cells 11 adjacent to each other in the arrangement direction.

The positive electrode plate 21 of the battery cell 11 that is located on the left side in the third layer of the assembled battery 91 is coupled to a total positive electrode terminal 92 for output. The negative electrode plate 22 of the battery cell 11 that is located on the right side in the third layer of the assembled battery 91 is coupled to a total negative electrode terminal 93 for output. As indicated by a one-dot chain line 94, which schematically indicates the flow of a current, in the assembled battery 91, the series-parallel coupling structure is achieved with the above-described coupling structure 70 for the battery cells 11. The battery cells 11 are arranged with gaps at the boundaries 95 in the arrangement direction (left-right direction), so that the gaps can be used as passages for cooling air.

As described above, the coupling structure 70 for the battery cells 11 achieves the series, parallel, or series-parallel coupling structure with one type of battery cells 11 and multiple types of electrode coupling plates 71, 77, and 78. Because the facility for manufacturing the battery cells 11 is usually expensive, the manufacturing cost of the battery cells 11 is high. However, the use of multiple types of electrode coupling plates 71, 77, and 78 enables the use of one type of battery cells 11. Thus, the manufacturing cost is significantly reduced.

In the coupling structure 70 for the battery cells 11 according to this embodiment, the case has been described where the battery cells 11 are stacked in three layers in the height direction (top-bottom direction), as illustrated in FIG. 12A. However, the disclosure is not limited to this case. Also in the coupling structure 70 for the battery cells 11, for example, similarly to the coupling structure 10 for the battery cells 11 described with reference to FIGS. 4A and 4B, the battery cells 11 may be arranged in the arrangement direction (left-right direction) in one layer in the height direction. Also in this case, by achieving the series, parallel, or series-parallel coupling structure with one type of battery cells 11 and multiple types of electrode coupling plates 71, 77, and 78, the same advantages as those described above are obtained.

In the coupling structure 70 for the battery cells 11 according to this embodiment, as illustrated in FIG. 12A, for example, the seventh electrode coupling plate 78B, the third electrode coupling plate 71C, the first electrode coupling plate 71A, the first electrode coupling plate 71A, the first electrode coupling plate 71A, and the fifth electrode coupling plate 77B are disposed from the left side between the first and second layers of the battery cells 11. However, the disclosure is not limited to this case. Also in the coupling structure 70 for the battery cells 11, for example, similarly to the coupling structure 10 for the battery cells 11 described with reference to FIG. 9, the insulating substrate 32 of the fifth electrode coupling plate 77B may be large enough to correspond to six battery cells 11 arranged in the arrangement direction (left-right direction). Also in this case, the insulating substrate 32 constituting the electrode coupling plate 77 has a uniform structure, and the same advantages as those described above can be obtained.

In the coupling structure 70 for the battery cells 11 according to this embodiment, the case has been described where the total positive electrode terminal 92 of the assembled battery 91 is coupled to the battery cell 11 on the left side in the third row, and the total negative electrode terminal 93 of the assembled battery 91 is coupled to the battery cell 11 on the right side in the third row. However, the disclosure is not limited to this case. For example, the total positive electrode terminal 92 and the total negative electrode terminal 93 may be disposed at positions close to each other by changing the arrangement of the electrode coupling plates 71, 77, and 78. In other words, the positions of the total positive electrode terminal 92 and the total negative electrode terminal 93 can be changed as desired. By disposing the total positive electrode terminal 92 and the total negative electrode terminal 93 close to each other, various advantages, such as elimination of the need for long bus bars and prevention of a short circuit at the time of collision, are obtained according to the purpose of design. The same advantages are obtained with the assembled battery 81. Various other modifications can be made without departing from the gist of the disclosure.

In the battery-cell coupling structure according to the embodiment of the disclosure, multiple battery cells are arranged in a laid manner in a first direction. The battery cells are coupled in series, parallel, or series-parallel by being electrically coupled to one another by the electrode coupling plates. Multiple patterns of the electrode coupling plates are prepared by the presence, absence, and combination of the first coupling terminal, the second coupling terminal, the third coupling terminal, and the fourth coupling terminal. Thus, the battery-cell coupling structure is formed with one type of battery cells and multiple types of electrode coupling plates. Because the facility for manufacturing the battery cells is usually expensive, the manufacturing cost of the battery cells is high. However, by enabling the use of one type of battery cells, the manufacturing cost is significantly reduced. Furthermore, because an assembled battery can be formed by stacking the battery cells and the electrode coupling plates, manufacturing of the assembled battery is simplified. Thus, the manufacturing cost is reduced. In addition, because the electrodes are fixed without using welding or bolt fastening, the assembled battery can be easily disassembled for recycling.

1. A battery-cell coupling structure comprising:
battery cells arranged in a laid manner in a first direction at least in one layer in a thickness direction of the battery cells, the thickness direction being orthogonal to the first direction; and
an electrode coupling plate, the battery-cell coupling structure being configured to electrically couple the battery cells to each other with the electrode coupling plate, wherein
each of the battery cells comprises a first electrode provided at a first end in a second direction orthogonal to the first direction and a second electrode provided at a second end in the second direction,
the electrode coupling plate comprises:
an insulating substrate;
a first coupling terminal provided at one or both of a first end and a second end of a first main surface of the insulating substrate in the thickness direction;
a second coupling terminal provided at one or both of the first end and the second end of a second main surface of the insulating substrate opposite to the first main surface;
a third coupling terminal provided at the first end or the second end so as to extend in the thickness direction of the insulating substrate to electrically couple the first coupling terminal and the second coupling terminal to each other or so as to penetrate through the insulating substrate to be exposed from the first main surface and the second main surface; and
a fourth coupling terminal provided at the second end or the first end opposite to the end provided with the third coupling terminal so as to extend in the thickness direction of the insulating substrate to electrically couple the first coupling terminal and the second coupling terminal to each other or so as to penetrate through the insulating substrate to be exposed from the first main surface and the second main surface,
one or both of the first coupling terminal and the second coupling terminal of the electrode coupling plate are disposed so as to straddle a boundary between adjacent battery cells of the battery cells in the first direction, and
electrode coupling plates including the electrode coupling plate are configured to electrically couple or decouple adjacent battery cells of the battery cells in the first direction to couple the battery cells in series, parallel, or series-parallel depending on combinations of presence and absence of each coupling terminal of the electrode coupling plates corresponding to the first coupling terminal, the second coupling terminal, the third coupling terminal, and the fourth coupling terminal.

2. The battery-cell coupling structure according to claim 1, wherein,
when the battery cells are stacked in two or more layers in the thickness direction, the electrode coupling plate is disposed between the layers of the battery cells, and
the third coupling terminal and the fourth coupling terminal are disposed so as not to straddle the boundary between adjacent battery cells of the battery cells in the first direction and are configured to electrically couple adjacent battery cells of the battery cells in the thickness direction.

3. The battery-cell coupling structure according to claim 1,
wherein the insulating substrate of the electrode coupling plate is disposed so as to straddle, at the first end, the boundary between adjacent battery cells of the battery cells in the first direction and so as not to straddle, at the second end, the boundary between adjacent battery cells of the battery cells in the first direction.

4. A battery-cell coupling structure comprising:
battery cells arranged in a laid manner in a first direction at least in one layer in a thickness direction of the battery cells, the thickness direction being orthogonal to the first direction; and
an electrode coupling plate, the battery-cell coupling structure being configured to electrically couple the battery cells to each other with the electrode coupling plate, wherein
each of the battery cells comprises a first electrode provided at a first end in the first direction and a second electrode provided at a second end in the first direction,
the electrode coupling plate comprises:
an insulating substrate;
a first coupling terminal provided on a first main surface of the insulating substrate in the thickness direction;
a second coupling terminal provided on a second main surface of the insulating substrate opposite to the first main surface;
a third coupling terminal provided so as to extend in the thickness direction of the insulating substrate to electrically couple the first coupling terminal and the second coupling terminal to each other or so as to penetrate through the insulating substrate to be exposed from the first main surface and the second main surface; and
a fourth coupling terminal provided so as to extend in the thickness direction of the insulating substrate to electrically couple the first coupling terminal and the second coupling terminal to each other or so as to penetrate through the insulating substrate to be exposed from the first main surface and the second main surface,
electrode coupling plates including the electrode coupling plate comprise each terminal corresponding to the first coupling terminal and the second coupling terminal, and disposed so as to straddle a boundary between adjacent battery cells of the battery cells at least in the first direction such that the first electrode and the second electrode face each other, and
the electrode coupling plates are configured to electrically couple or decouple adjacent battery cells of the battery cells in the first direction to couple the battery cells in series, parallel, or series-parallel depending on combinations of presence and absence of each coupling terminal of the electrode coupling plates corresponding to the first coupling terminal, the second coupling terminal, the third coupling terminal, and the fourth coupling terminal.

5. The battery-cell coupling structure according to claim 4, wherein,
when the battery cells are stacked in two or more layers in the thickness direction, the electrode coupling plate is disposed between the layers of the battery cells, and
the third coupling terminal and the fourth coupling terminal are configured to electrically couple adjacent battery cells of the battery cells in the thickness direction.

6. The battery-cell coupling structure according to claim 1, wherein
the electrode coupling plate comprises one insulating substrate that corresponds to the battery cells arranged in the first direction, and
one or more of the first coupling terminal, the second coupling terminal, the third coupling terminal, and the fourth coupling terminal are disposed so as to straddle the boundary between adjacent battery cells of the battery cells in the first direction.

7. The battery-cell coupling structure according to claim 1, wherein
the electrode coupling plate comprises one insulating substrate that corresponds to the battery cells arranged in the first direction, and
the first coupling terminal and the second coupling terminal are disposed so as to straddle the boundary between adjacent battery cells of the battery cells in the first direction.

8. The battery-cell coupling structure according to claim 1, wherein each of the first electrode and the second electrode is provided to so as to protrude outward from the battery cells.

9. The battery-cell coupling structure according to claim 4, wherein each of the first electrode and the second electrode is provided to so as to protrude outward from the battery cells.

10. The battery-cell coupling structure according to claim 1, wherein an arrangement region in the electrode coupling plate where the first coupling terminal and the second coupling terminal are provided protrudes in the thickness direction of the insulating substrate.

11. The battery-cell coupling structure according to claim 4, wherein an arrangement region in the electrode coupling plate where the first coupling terminal and the second coupling terminal are provided protrudes in the thickness direction of the insulating substrate.

12. The battery-cell coupling structure according to claim 6, wherein an arrangement region in the electrode coupling plate where the first coupling terminal and the second coupling terminal are provided protrudes in the thickness direction of the insulating substrate.

13. The battery-cell coupling structure according to claim 7, wherein an arrangement region in the electrode coupling plate where the first coupling terminal and the second coupling terminal are provided protrudes in the thickness direction of the insulating substrate.
